(19) United States
(12) Patent Application Publication
(10) Pub. No.: US 2010/0132501 A1
(43) Pub. Date: Jun. 3, 2010

(54) BOOM STEERING SYSTEMS

(75) Inventor: Eric John Owen, Queensland (AU)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: ERIC & KARYN OWEN PTY LTD, Queensland (AU)

(21) Appl. No.: 12/599,022

(22) PCT Filed: May 8, 2008
(86) PCT No.: PCT/AU2008/000643

§ 371 Date: Nov. 5, 2009

(30) Foreign Application Priority Data
May 8, 2007 (AU) 2007902435

(51) Int. Cl. G05G 1/34; G05G 1/00

(52) U.S. Cl. 74/514; 74/469

(57) ABSTRACT

A swing control apparatus for a boom comprising at least one rod attached to an arm, at least one sector gear attached to the arm and a translation gear interconnected with the at least one sector gear wherein, the movement of the rod causes movement of the arm and sector gear, resulting in movement of the translation gear which is translated into an electrical signal to thereby move the boom of the dragline excavator.

### FIELD OF THE INVENTION

The present invention relates to the field of boom steering systems. One particular field to which this invention relates is to dragline boom control apparatus, although the invention is adapted to use for steering or controlling an elongate boom for virtually any purpose.

### BACKGROUND ART

Surface mining requires the removal of huge amounts of overburden to expose the valuable deposits located underneath, such as coal. This can involve the moving of many thousands of tons of soil and rocks and is a costly and time consuming process. Reduction of overburden removal costs has been identified as the most important means of improving the economic performance of open cut coal mines.

Typically, overburden removal is achieved using a dragline excavator. These massive machines can displace up to 450 metric tones of material in a single operation cycle and, depending on the size of the mine, a number of them may be employed at any one time.

A dragline employs a large bucket which is suspended from a boom by a series of hoist ropes and couplers. The bucket is positioned above the overburden and lowered and then a drag rope is used to draw the bucket through the material and fill it. The bucket is then raised and a swing operation is performed by the operator to position the bucket over the place where the material is to be dumped. The drag rope is then released which thereby allows the bucket to tip and empty its contents before another swing operation manoeuvres the bucket back over the overburden.

Draglines are extremely expensive to purchase and may cost between US $50-100 million. Because of their size they are also expensive to maintain, repair and run and so any improvement in their operation or any reduction of downtime can represent large savings for the mining industry. It has been estimated that a 1% increase in dragline productivity returns about AU $1 million each year in additional revenue to a mine. It is therefore essential to minimise the amount of downtime for these machines.

Two foot pedals are generally used to operate the swing motors which in turn rotate the boom and so bring about the swing cycle i.e. when the left foot pedal is depressed the boom swings to the left and vice versa.

Prior art swing control mechanisms typically employ a series of crown wheels which are driven by depression of the foot pedals via a pinion or idler gear. This system in turn drives various switching gears to engage the swing motors and bring about movement of the boom.

These swing cycle control systems are usually complex and with relatively large numbers of interconnecting moving parts there is a greater chance that at least one component will break down and thereby require the dragline to be stopped. The constant push for greater efficiency in the mining industry to maximise profits means that the draglines are required to be operational for greater periods of time and that down time is becoming a serious financial concern.

Hence, it is desirable to provide for a dragline swing operating system which is simple and which has fewer moving parts than those of the prior art. This should result in less maintenance, fewer breakdowns and hence less downtime of the dragline. This can result in improved efficiency and large savings across the mining industry.

Again, although the above description of shortcomings is directed to dragline booms, the invention is not limited to application in that field.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a boom steering system or swing control apparatus for a boom, which may at least partially overcome at least one of the abovementioned disadvantages or provide the consumer with a useful or commercial choice.

In one form, although it need not be the only or indeed the broadest form, the invention resides in a swing control apparatus for a boom comprising:

(a) at least one rod attached to an arm;

(b) a sector gear attached to the arm; and

(c) a translation gear interconnected with the sector gear;

wherein, the movement of the rod causes movement of the arm and sector gear, resulting in movement of the translation gear which is translated into an electrical signal to thereby move the boom of the dragline excavator.

The apparatus of the present invention typically includes a housing in which many of the components of the mechanism are contained. Preferably, the housing is substantially rectangular in shape and has an upper wall. In use, the upper wall will typically be fitted and function as a portion of the floor in a cabin in which the apparatus of the invention is used.

At least one and typically a pair of foot pedal actuation means are provided adjacent the upper wall of the housing and which stand proud of the upper wall. The foot pedals preferably communicate with the mechanism located within the housing to translate the movement of the foot pedals into control information for movement of the boom.

The housing preferably protects the mechanism and also allows the quick and simple retrofitting as well as removal and replacement of the apparatus into a standard sized opening.

Typically the foot pedals are mounted above the upper wall of the housing and are movable downwardly relative to the wall. Normally, a biasing means to bias the foot pedal into an upward position will be provided. It is also preferred that one end of each foot pedal, normally the rear or heel end of the pedal is rotatably mounted relative to the housing. In this manner, depression of the forward or toe end of the pedal is possible. A heel cup is preferably provided on each foot pedal such that a user's foot does not slip from the rear of the pedal.

Each foot pedal is preferably associated with a rod extending substantially downwardly into the housing and connected to the arm. Preferably each rod attaches to an end of the arm. Each rod is typically mounted substantially vertically and is pivotally connected to the pedal at an upper end and pivotally connected to the arm at a lower end.

The arm is preferably mounted to extend substantially horizontally within the housing. Suitably, the arm is pivotally connected and adapted to rotate about a central pivot. Mounting plates may be used to sandwich the arm therebetween to locate the arm. Each rod is preferably attached to the arm at or adjacent an end of the arm rather than an intermediate point as this maximises the length of travel of the rod.

In use, depression of the foot pedal causes downward movement of the rod and the end of the arm to which the rod is connected.

Preferably, the arm pivots about a centrally located shaft. Of course, more complex mechanisms can be provided which achieve the same function.

Typically, the sector gear is fixedly attached to the arm. The sector gear may be an annular sector to minimise the amount of material and therefore weight of the apparatus. There are normally two sector gears are provided, with one sector gear located between the central shaft of the arm and each outer end of the arm. The sector gear is preferably oriented with the teeth of the gear toward the end of the arm. Each sector gear is preferably attached to the arm in a substantially rigid manner.

Preferably, a pair of translation gears is provided, with one translation gear located adjacent each sector gear. Suitably, the sector gear is interconnected with the translation gear by the teeth of the gears. Each translation gear is typically connected to an encoder and resolver unit with translates the rotation (and typically the degree of rotation) of the translation gear into control signals to control movement of the boom.

Preferably, the movement of the translation gear which is translated into an electrical signal is a rotational movement.

Each translation gear will normally be a substantially circular gear. The encoder and resolver unit(s) may be mounted within the housing and therefore may be a part of the apparatus of the invention connectable to the boom control mechanism of the equipment to which to which the apparatus is attached, or the encoder and resolver unit(s) may be external and connectable to the apparatus of the invention once the apparatus is installed.

### BRIEF DESCRIPTION OF THE DRAWINGS

In order that the invention may be readily understood and put into practical effect, preferred embodiments will now be described by way of example with reference to the accompanying figures wherein like reference numerals refer to like parts and wherein:

FIG. 1 shows a perspective view of a swing control apparatus according to an embodiment of the invention;

FIG. 2 shows a perspective view of the underside of a left pedal of the swing control apparatus shown in FIG. 1;

FIG. 3 shows a front view of the swing control apparatus shown in FIG. 1; and

FIG. 4 is a view of part of the swing control apparatus shown in FIG. 3.

### DETAILED DESCRIPTION OF THE PREFERRED EMBODIMENT

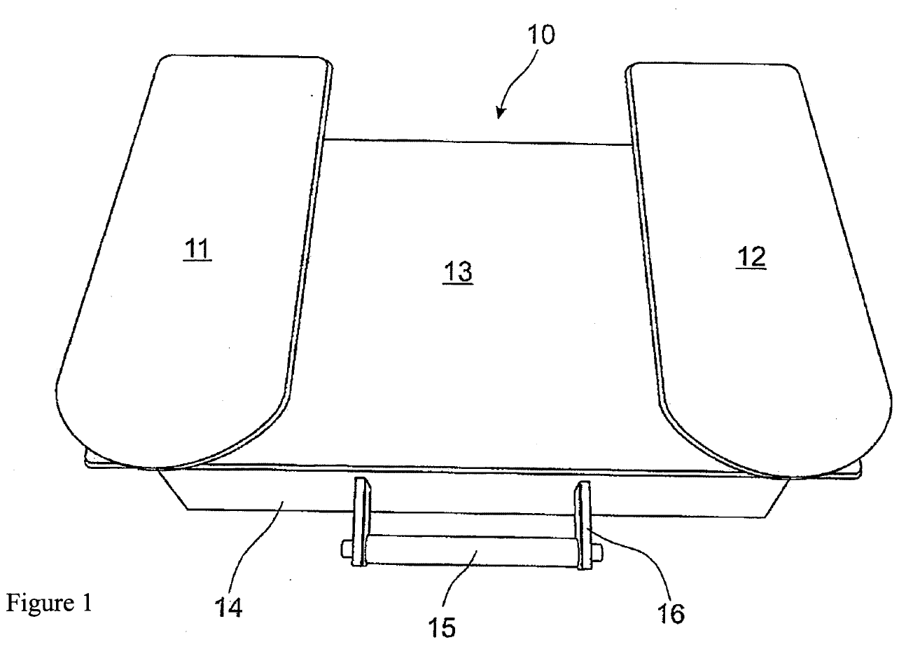

FIG. 1 shows a perspective view of a swing control apparatus according to an embodiment of the invention. The swing control apparatus 10 comprises a right pedal 11, a left pedal 12, a cover plate 13 and a front end 14. A handle 15 is also provided to allow the apparatus 10 to be adjusted by each driver to suit their favoured driving position. The handle 15 is connected to the front end 14 by way of connecting members 16.

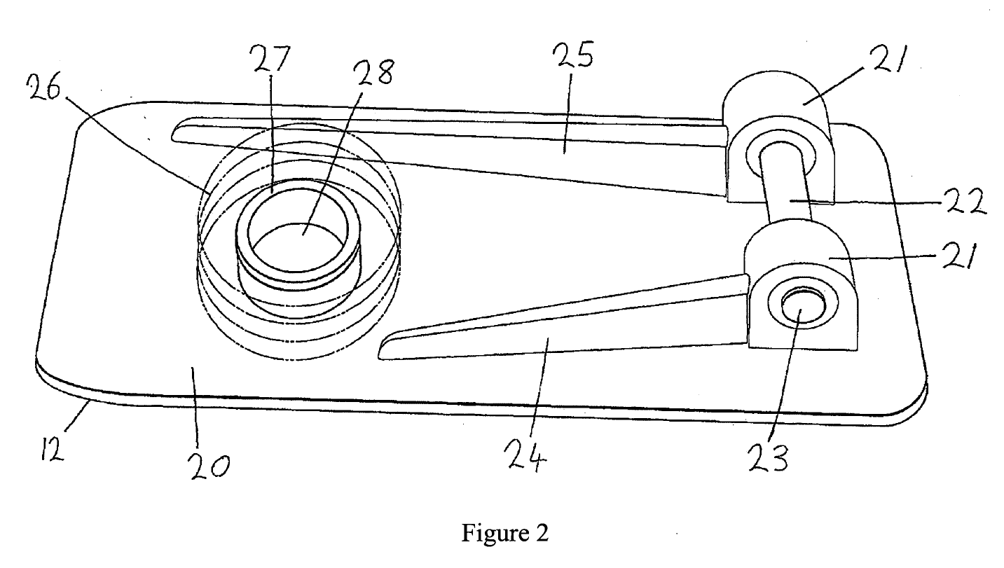

FIG. 2 shows a perspective view of the underside of a left pedal of the swing control apparatus shown in FIG. 1. The underside surface 20 of left pedal 12 has two bearing housings 21 attached at one end. The bearing housings 21 and the underside surface 20 are gusset 24 and elongate gusset 25.

A bellow means 26 is shown in outline at the other end of the left pedal 12 from the bearing housings 21. Also shown is a sock 27 which is provided with an aperture 28. The same features are present on the underside of the right pedal 11.

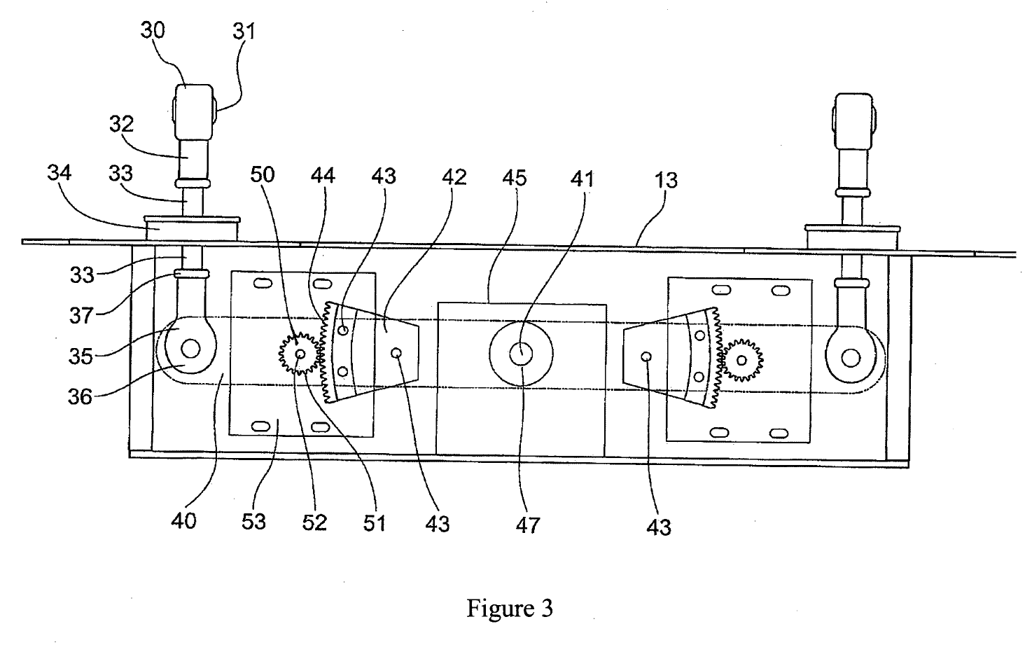

FIG. 3 shows a front view of the swing control apparatus shown in FIG. 1. The various components are reproduced on each side of the device i.e. the same control system is provided for each of the right pedal 11 and left pedal 12. Since a plane of symmetry can be seen to exist, drawn vertically through the central shaft 41 on FIG. 3, only one side of the figure will be described. It should be appreciated that the same description of components applies to the opposite side of FIG. 3.

An upper rod end 30 is received by socket 27 and is connected via pivot 31. Clearance for the end of upper rod end 30 is provided by aperture 28. Upper rod end 30 has a cuff 32 which engages with a shaft 33. Shaft 33 penetrates through mounting block 34 to then engage with the cuff 37 of lower rod end 35. Lower rod end 35 is connected to rocker arm 40 via pivot 36.

Rocker arm 40 is an elongate structure which pivots around a central shaft 41 which is supported by bearing 47 in first support plate 45. Attached to rocker arm 40 via bolts is sector gear 42. At one end, sector gear 42 has provided a plurality of gear teeth 44. These engage with the gear teeth 51 of translation gear 50 which moves around a central axle 52.

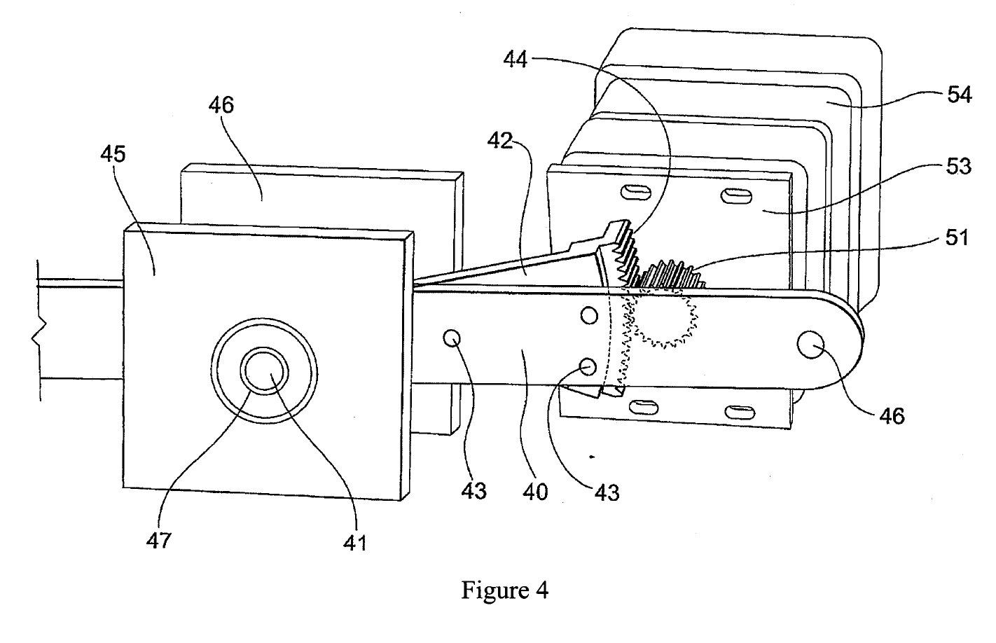

FIG. 4 shows an exploded view of the apparatus shown in FIG. 3. The particular focus is on one end of rocker arm 40 and the engagement of sector gear 42 with translation gear 50. Central shaft 41 is flush with the front face of first support plate 45 and extends through the rocker arm and through second support plate 46.

The engagement of the gear teeth 44 of sector gear 42 with the gear teeth 51 of translation gear 50 can be clearly seen in FIG. 2. Translation gear 50 is supported by translation support plate 53. The central axle 52 (not visible in FIG. 4) of translation gear 50 extends through translation support plate 53 and into encoder and resolver assembly 54.

When the swing control apparatus 10 is suitably installed into a dragline console it allows the operator to control the side to side motion of the boom and hence the bucket. This enables the operator to position the bucket for filling and subsequently to move it to a position where the overburden can be conveniently dumped.

One sequence of events will now be described which would result in the boom swinging in a leftwards direction. When the operator applies a downward force to the front end of the left pedal 12 the pedal is depressed by an amount corresponding to the extent of that force. Since upper rod end 30 is connected to the underside 20 of the pedal it propagates that downward force through the shaft 33 and on to lower rod end 35.

The pivot 36 connecting lower rod end 35 and rocker arm 40 results in that particular end of rocker arm 40 also being depressed as it rotates about central shaft 41 in bearing 47. Since sector gear 42 is fixedly attached to rocker arm 40 by bolts 43, it moves down in an arcuate motion with the rocker arm 40 and its gear teeth 44 engage with the gear teeth 51 of translation gear 50 as it moves to bring about the rotation of translation gear 50.

It should be appreciated that the further the left pedal 12 is depressed towards the cover plate 13 the further the sector gear 42 will be forced downwards and, ultimately, the greater the resulting rotation of translation gear 50. The central axle 52 of translation gear 50 is rotated along with translation gear 50 and this is connected to an encoder and resolver assembly 54.

The degree of rotation of central axle 52 is converted to a digital signal by the encoder and resolver assembly 54. This signal drives the appropriate swing motor to swing the boom to the left by a certain amount. It should be clear that by fine control of the pressure the operator places on the foot pedals, the degree of swing of the boom can be controlled.

Due to the rocker arm moving around central shaft 41, when one side of the rocker arm 40 is depressed then the other side will become elevated. This is translated through the lower and upper rod ends 35 and 30 to cause the pedal which is not having a downward force applied to it to be elevated.

The kinds of encoder and resolver assemblies which are useful for translating the mechanical rotation of translation gear 50 and central axle 52 into an electrical pulse and the subsequent switching mechanisms of this resulting in movement of the boom are well known in the art and require no further explanation here. The manner in which the mechanical rotation is generated to thereby send a mechanical signal to the encoder etc. is the focus of the present invention.

When the operator wants the boom to swing to the right he merely presses down on the now elevated right pedal 11 and the same sequence of events is repeated by at the other end of the swing control apparatus 10 i.e. the components under the right pedal side.

Each upper rod end 30 and lower rod end 35 must be able to cope with both the up and down and arcuate motions of rocker arm 40 and right pedal 11 and left pedal 12. To accommodate this, pivots 31 and 36 may comprise multi-directional bearings.

It will be appreciated that it is the engagement of gear teeth 44 and 51 which directly results in the conversion of the downward force placed on the pedal into the rotational motion which is subsequently translated by the encoder assembly and other means into an electronic signal. This engagement could take place in a range of different ways which would be known to the skilled addressee.

FIG. 2 showed that each pedal may have a bellow means 26 on their underside. The bellow means 26 serve to keep dust and debris from entering the internal workings of apparatus 10 via the opening created when the shaft 33 of upper rod ends 30 penetrates through the upper surface 13 of the apparatus. The bellow means are connected from the underside of the pedal to the mounting block 34 and may take the form of various bellow type devices which are known in the art such as a concertina arrangement.

Socket 27 and aperture 28 form the connection of the pedals with upper rod end 30. This may take a number of forms such as a ball and socket arrangement. Socket 27 may be a cast lug to which the upper rod end 30 is screwed into. Aperture 27 then provides the necessary clearance for the ball shaped end of upper rod end 30.

When the apparatus 10 is installed within a dragline console it may be operational for long periods at a time. As was mentioned earlier, the more robust the components are, the better, as any downtime on the dragline is very costly to the mine operators. The various components hereinbefore described may, therefore, be made from a range of materials so long as said materials are strong and hard wearing e.g. the pedals may be constructed from cast aluminium plates. Appropriate materials would be well known to a person skilled in the art.

It should be appreciated that the provision of a rocker arm 40 with a section gear 42 connected to the pedals 11 and 12 allows the translation of varying degrees of downward force on a pedal into rotation of a component which is then converted into a corresponding signal to move a dragline boom. This results in a mechanism with a relatively small number of moving parts and so, less to go wrong. The simplicity of the sequence of events also means the apparatus is a robust way of controlling boom swing.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

What is claimed is:

1. A swing control apparatus for a boom comprising:
(a) at least one rod attached to an arm;
(b) at least one sector gear attached to the arm; and
(c) at least one translation gear interconnected with the at least one sector gear;
wherein, the movement of the rod causes movement of the arm and sector gear, resulting in movement of the translation gear which is translated into an electrical signal to thereby move the boom of a dragline excavator.

2. A swing control apparatus as claimed in claim 1 further including a housing in which are the arm, the at least one rod, at least one sector gear, and at least one translation gear are contained.

3. A swing control apparatus as claimed in claim 2 wherein the housing is substantially rectangular in shape and has an upper wall which in use, functions as a portion of the floor in a cabin in which the apparatus is installed.

4. A swing control apparatus as claimed in claim 2 further including a pair of foot pedal actuation means provided adjacent the upper wall of the housing.

5. A swing control apparatus as claimed in claim 4 wherein the foot pedals communicate with the arm located within the housing to translate the movement of the foot pedals into control information for movement of the boom.

6. A swing control apparatus as claimed in claim 4 wherein the foot pedals are mounted above the upper wall of the housing and are movable downwardly relative to the wall.

7. A swing control apparatus as claimed in claim 4 wherein a biasing means to bias the foot pedals into an upward position is provided.

8. A swing control apparatus as claimed in claim 4 wherein a rear or heel end of each foot pedal is rotatably mounted relative to the housing.

9. A swing control apparatus as claimed in claim 4 wherein a heel cup is provided on each foot pedal such that a user's foot does not slip from the rear of the pedal.

10. A swing control apparatus as claimed in claim 4 wherein each foot pedal is associated with a rod extending substantially downwardly into the housing and connected to the arm.

11. A swing control apparatus as claimed in claim 4 wherein each rod is mounted substantially vertically and is pivotally connected to a pedal at an upper end and pivotally connected to the arm at a lower end.

12. A swing control apparatus as claimed in claim 2 wherein the arm is mounted to extend substantially horizontally within the housing and is pivotally connected and adapted to rotate about a central pivot.

13. A swing control apparatus as claimed in claim 1 wherein each rod is attached to the arm at or adjacent an end of the arm rather than an intermediate point to maximize the length of travel of the rod and arm.

14. A swing control apparatus as claimed in claim 1 wherein each sector gear is an annular sector.

15. A swing control apparatus as claimed in claim 1 wherein two sector gears are provided, with one sector gear located between a central pivot of the arm and each outer end of the arm with each sector gear oriented with the teeth of the gear toward the end of the arm.

16. A swing control apparatus as claimed in claim 1 wherein a pair of translation gears is provided, each translation gear located adjacent a sector gear.

17. A swing control apparatus as claimed in claim 1 wherein a sector gear is interconnected with a translation gear by the teeth of the respective gears.

18. A swing control apparatus as claimed in claim 1 wherein each translation gear is connected to an encoder and resolver unit which translates the rotation of the translation gear into control signals to control movement of the boom.

19. A swing control apparatus as claimed in claim 4 wherein a rotational movement of the translation gear is translated into an electrical gear.
